(19) United States
(12) Patent Application Publication
(10) Pub. No.: US 2025/0030190 A1
(43) Pub. Date: Jan. 23, 2025

(54) PLUGGABLE CONNECTOR OF AN ELECTRICAL PLUG-IN CONNECTION

(71) Applicant: WAGO Verwaltungsgesellschaft mbH, Minden (DE)

(72) Inventor: Philipp OBER-WOERDER, Minden (DE)

(73) Assignee: WAGO Verwaltungsgesellschaft mbH, Minden (DE)

(21) Appl. No.: 18/774,736

(22) Filed: Jul. 16, 2024

(30) Foreign Application Priority Data
Jul. 17, 2023 (DE) 20 2023 103 985.5

(51) Int. Cl. H01R 13/508; H01R 13/05

(52) U.S. Cl. CPC H01R 13/508; H01R 13/052

(57) ABSTRACT

A pluggable connector of an electrical connector comprising the pluggable connector and a mating connector assigned to the pluggable connector as a counterpart to which the pluggable connector is pluggable in one plug direction. The pluggable connector has a housing and several electrical plug contacts at least partially located in the housing, each of which having a plug section which is designed to come into contact mechanically and electrically with a mating plug contact of the mating connector. The housing has a contact chamber to accommodate the plug sections of the plug contacts. The contact chamber has sidewalls limiting the circumference, at least in the area of the plug sections arranged therein.

This nonprovisional application claims priority under 35 U.S.C. § 119(a) to German Patent Application No. 20 2023 103 985.5, which was filed in Germany on Jul. 17, 2023, and which is herein incorporated by reference.

### BACKGROUND OF THE INVENTION

### Field of the Invention

The invention relates to a pluggable connector of an electrical plug connection comprising the pluggable connector and a mating connector assigned to the pluggable connector as a counterpart to which the pluggable connector is pluggable in one plug direction(S), wherein the pluggable connector has a housing and several electrical plug contacts at least partially located in the housing, each of which having a plug section designed to come into contact mechanically and electrically with a mating plug contact of the mating connector, wherein the housing has a contact chamber to accommodate the plug sections of the plug contacts, wherein the contact chamber has sidewalls limiting the circumference, at least in the area of the plug sections arranged therein.

### Description of the Background Art

A generic connector is known from EP 2 953 213 B1, which corresponds to US 2015/0357756, which is incorporated herein by reference.

### SUMMARY OF THE INVENTION

It is therefore an object of the invention to further improve such a pluggable connector of an electrical plug connection with regard to universal applicability and flexibility for the user.

In the case of a pluggable connector, this object is achieved by the pluggable connector having at least one first fastening element designed to attach a functional element to the housing outside the contact chamber and by the pluggable connector having at least a second fastening element designed to attach a functional element to the housing inside the contact chamber. Accordingly, it is proposed to provide at least one internal and at least one external fastening element on a pluggable connector at the same time.

The pluggable connector has the advantage that the fastening elements set up for mounting inside and outside the contact chamber provide extended possibilities for attaching functional elements to the housing. In principle, functional elements of any kind can be attached to the second and first fastening elements. If, for example, coding elements are attached there as functional elements, the additional fixing options can increase the coding possibilities by doubling the coding positions. Especially for pluggable connectors with a low number of poles, this can significantly increase the coding possibilities.

The at least one second fastening element and/or first fastening element may be located on the housing or may be designed as an integral part of the housing. For example, at least one first fastening element designed to attach a functional element to the housing may be located outside the contact chamber and at least one second fastening element designed to attach a functional element to the housing may be located inside the contact chamber.

The pluggable connector according to the invention gives the user the possibility to equip the pluggable connector with one or more functional elements as needed in a manner that is much more flexible than the prior state of the art. The pluggable connector can thus be adapted to a much greater extent according to the customer's wishes or the wishes of the end user in individual cases without this being associated with great effort. In addition, there are manufacturing advantages because uniform pluggable connectors are provided for a variety of applications, which can be adapted by the customer or end user by attaching one or more functional elements to at least one second and/or first fastening element.

The at least one second fastening element and/or first fastening element may be formed as a form-fitting fastening element, as a force-fit fastening element or as a combination thereof, i.e., as both a form-fitting and a force-fit fastening element. By means of the at least one second fastening element and/or first fastening element, a functional element can thus be attached to the housing of the pluggable connector.

The at least one second fastening element and/or the first fastening element may be formed as a recess in a respective housing wall, i.e., as an area that is lowered with respect to the level of the surface of the housing wall, e.g., in the form of a blind hole, a receiving groove or other receiving recess. The at least one second and/or first fastening element may also be formed as an elevation in relation to the respective housing wall, i.e., as a fastening element that protrudes with respect to the surface of the housing wall, e.g., in the form of a fixing stud, a fixing rail or another fixing elevation. The second fastening element can be the same as the first fastening element or differently designed, i.e., the second and the first fastening element can each be designed separately from each other according to any one of the examples explained above.

Insofar as a second receiving groove is referred to below, this describes an example of the second fastening element in the form of a groove-like recess. Insofar as the following refers to a first receiving groove, this describes an example of the first fastening element in the form of a groove-like recess.

The at least one second fastening element and/or first fastening element may be designed in particular as a universal fastening element or as a universal fastening element for the fixation of a wide variety of functional elements that can be selected by the user. With the at least one second fastening element and/or first fastening element, the different functional elements can be fastened, e.g., near the plug-in face of the pluggable connector. The plug-in face of a pluggable connector is the area that points in the plug direction towards the mating connector and is plugged together with the mating connector.

The functional elements may be designed for different functions of the pluggable connector, for example as a coding element for coding the pluggable connector, as a locking element for locking the pluggable connector with the mating connector to prevent accidental loosening, as a labeling element or other functional elements. Coding in this context means that a certain combination of coding elements is attached to the pluggable connector, which is assigned to a corresponding counter-coding on the mating connector, so that due to this coding, the pluggable connector can only be plugged into a correspondingly counter-coded mating connector.

A further advantage of the invention is that the arrangement and position of functional elements attached to the second and/or the first fastening element is not permanently fixed but can also be changed later if necessary. For example, re-coding of the pluggable connector or a change in the locking type can be carried out retrospectively.

The contact chamber in which the plug sections of the plug contacts are located may have a bottom wall with pass-through openings through which the plug contacts protrude into the receiving chamber from another area of the pluggable connector housing. The contact chamber can be open on the side facing away from the bottom wall. The sidewalls of the contact chamber can extend from the bottom wall to a free end of the contact chamber in the plug direction. Insofar as sidewalls are spoken of in the plural in this regard, these can be formed as contiguous sidewalls or as sidewalls with interruptions. The sidewalls can extend in a ring around the contact chamber and thus form a uniform circumferential wall. The contact chamber is designed to accommodate part of the housing of the mating connector. Thus, in the mated state of the pluggable connector and mating connector, in which the plug contacts of the pluggable connector come into contact with mating plug contacts of the mating connector, part of the housing of the mating connector is located in the contact chamber.

The pluggable connector can have multiple plug contacts arranged next to each other in a row direction A. The plug contacts can be arranged next to each other in a single row in the row direction, or in several rows.

For example, the at least one first fastening element can be placed on at least one outer wall of the housing that is located outside the contact chamber. The at least one first fastening element can also be arranged on the outside of a sidewall of the contact chamber, for example.

According to an advantageous design of the invention, it is provided that at least one second fastening element can be located on a sidewall of the contact chamber, in particular on the inside of such a sidewall. This allows for a functional element to be attached to the second fastening element in a simple way and with reliable fixation. For example, the functional element can be plugged into the second fastening element in the plug direction S. Alternatively, the at least one second fastening element or another second fastening element can also be arranged on the bottom wall of the contact chamber.

According to an advantageous design of the invention, it is provided that at least one second fastening element can be designed as a second receiving groove, e.g., as an inner receiving groove, in particular as a receiving groove with an undercut. This allows for functional elements to be reliably attached to the second fastening element. The second receiving groove can have a profile with an undercut, e.g., a mushroom profile, a dovetail profile, or a T-shaped profile.

The second receiving groove can extend in its longitudinal direction in the plug direction. This allows for a functional element to be easily and quickly plugged into the second receiving groove, as well as a simple release of the functional element.

At least one first fastening element can be formed as the first receiving groove, e.g., as an outer receiving groove, in particular as a receiving groove with an undercut. This allows for functional elements to be reliably attached to the first fastening element. The first receiving groove can have, for example, a profile with an undercut, e.g., a mushroom head profile, a dovetail profile, or a T-shaped profile.

The first receiving groove can extend in its longitudinal direction perpendicular to the plug direction and/or perpendicular to a row direction of the plug contacts. This allows for a simple and quick connection of a functional element to the first receiving groove, as well as a simple release of the functional element. The first receiving groove can extend essentially perpendicular to one or more second receiving grooves.

The pluggable connector can be designed as a pin header, wherein the plug sections of the plug contacts are designed as contact pins protruding into the contact chamber. Accordingly, the pluggable connector is designed as a male connector. The mating connector can have female plug contacts, i.e. socket contacts.

The contact chamber can be designed as a continuous contact chamber in which the plug sections are arranged without separation from each other. The contact chamber may also have partitions between individual plug sections or groups of plug sections.

The pluggable connector can have several second fastening elements and/or several first fastening elements. This further improves the ability to attach functional elements to the pluggable connector.

For one, several or all of the second fastening elements, the second fastening element can be spatially assigned to a plug contact of the pluggable connector. This can be achieved, for example, by the fact that a respective second fastening element is arranged in the plug direction in alignment with an electrical plug contact to which the second fastening element is assigned. This results in a good use of installation space for the attachment of a large number of functional elements to the housing of the pluggable connector and thus a large number of possible combinations of the functional elements.

For one, several or all of the first fastening elements, the first fastening element in each case can be spatially assigned to a plug contact of the pluggable connector. This can be achieved, for example, by the fact that a respective first fastening element is arranged in the plug direction in alignment with an electrical plug contact to which the first fastening element is assigned. This results in a good use of installation space for the attachment of a large number of functional elements to the housing of the pluggable connector and thus a large number of possible combinations of the functional elements.

The at least one second fastening element and/or at the least one first fastening element can be designed as a universal fixing element for fixing different functional elements to the housing selected by the user. Accordingly, the user can choose a functional element or a combination of functional elements suitable for his specific application from a predefined range of fixing elements and attach it to the second and first fastening elements of the pluggable connector.

At least one first fastening element can be arranged in the plug direction in alignment with a second fastening element assigned to the at least one first fastening element. In this way, a second fastening element is spatially assigned to the first fastening element.

At least one second fastening element and/or the at least one first fastening element can have a locking element for locking a functional element attached to the respective fastening element. This ensures that the functional element is firmly seated on the fastening element.

Advantageously, the second fastening element and the first fastening element do not affect each other, so that the fastening elements can be used independently. In particular, it is possible to attach a functional element each to a second fastening element and a first fastening element at the same time.

The second fastening element and the first fastening element can be separated from each other and not intersect.

If the at least one second fastening element and the at least one first fastening element are used, for example, for the coding of the pluggable connector, a second fastening element is particularly suitable for coding in implementations (device applications). A first fastening element is also clearly visible when the pluggable connector is plugged together with the mating connector and is therefore suitable, for example, for flying connections.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a pluggable connector in a perspective view,

FIG. 2 shows a pluggable connector in an example in a perspective view,

FIG. 3 shows a part of the pluggable connector according to FIG. 1 in a lateral sectional view, and

FIG. 4 shows a part of the pluggable connector according to FIG. 2 in a lateral sectional view.

### DETAILED DESCRIPTION

The figures show a pluggable connector 1 that has a housing 2. The pluggable connector 1 is designed to mate with a mating connector 6, which is designed as a counterpart to the pluggable connector 1. When mated together, the pluggable connector 1 and mating connector 6 form an electrical plug connection. The pluggable connector 1 has several electrical plug contacts 3 located at least partially in the housing 2. The plug contacts 3 each have a plug section 30, which is designed to come into contact mechanically and electrically with a mating plug contact 7 of the mating connector 6 when the pluggable connector is mated to the mating connector 6. In the example shown, the plug contacts 3 are designed as male plug contacts, which have contact pins as plug sections 30. Accordingly, the mating plug contact 7 is designed as a socket contact, which is designed to accommodate at least part of the plug section 30.

In particular, the pluggable connector 1 can be mated together with the mating connector 6 in a plug direction S. The plug contacts 3 are lined up next to each other in a row direction A.

The housing 2 has a contact chamber 20, which is located on a mating face side of the pluggable connector 1. The contact chamber 20 is designed as an essentially hollow chamber, which is circumferentially bounded by sidewalls 21, 22, 23, 24. The plug contacts 3 protrude into the contact chamber 20 with their plug sections 30.

The pluggable connector 1 has several first fastening elements 4, each of which is set up to attach a functional element 9 to the housing 2 outside the contact chamber 20. The pluggable connector 1 also has several second fastening elements 5 that are set up to attach a functional element 9 to the housing 2 within the contact chamber 20. The second fastening elements 5 may be formed, for example, on the inside of a sidewall 21, 22, 23, 24, e.g., as an elongated receiving groove extending in the plug direction S.

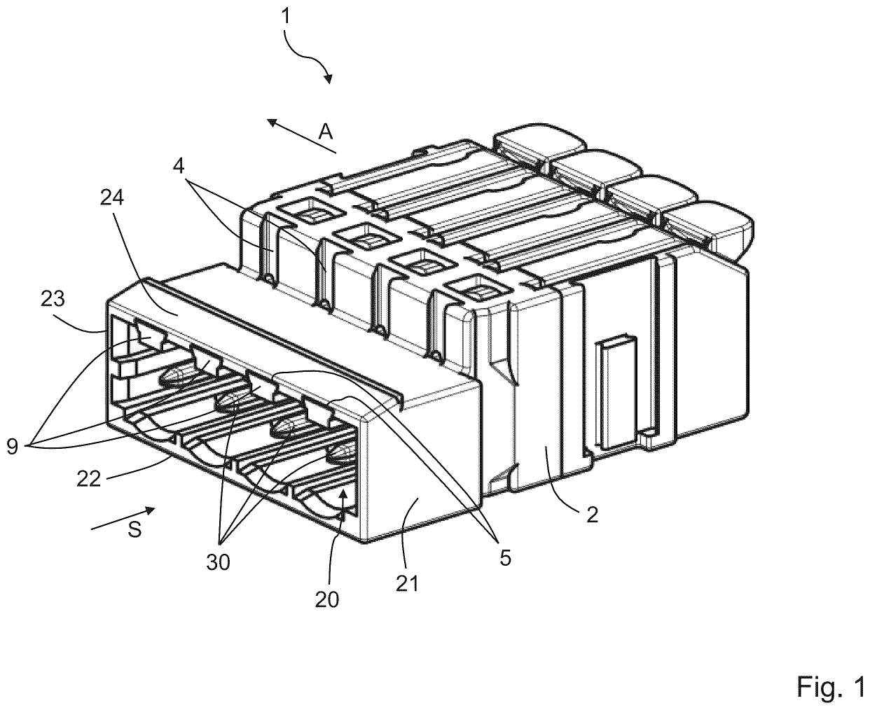

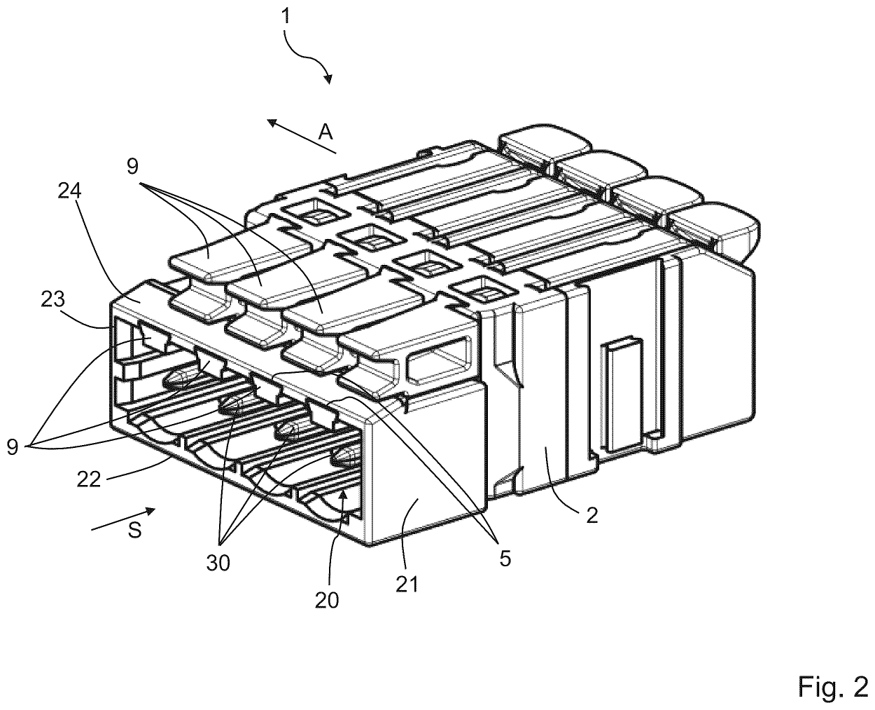

FIG. 1 shows that the pluggable connector 1 is equipped with a functional element 9 each on its second fastening element 5. According to FIG. 1, no functional elements 9 are arranged on the first fastening element 4. FIG. 2 shows an assembly situation in which in each case a functional element 9 is also attached to the first fastening element 4 on the pluggable connector 1. The user can specify at will whether one, several or all of the second fastening elements 5 are to be equipped with a functional element 9 and/or whether one, several or all of the first fastening elements 4 are to be equipped with a functional element 9. Accordingly, it is also possible to attach functional elements 9 only to the first fastening elements 4, for example.

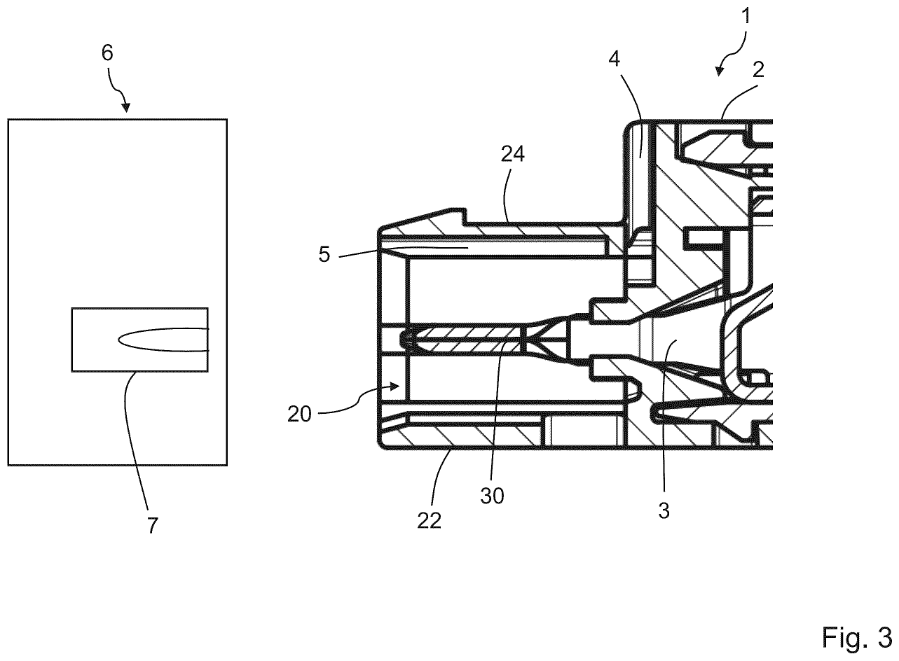

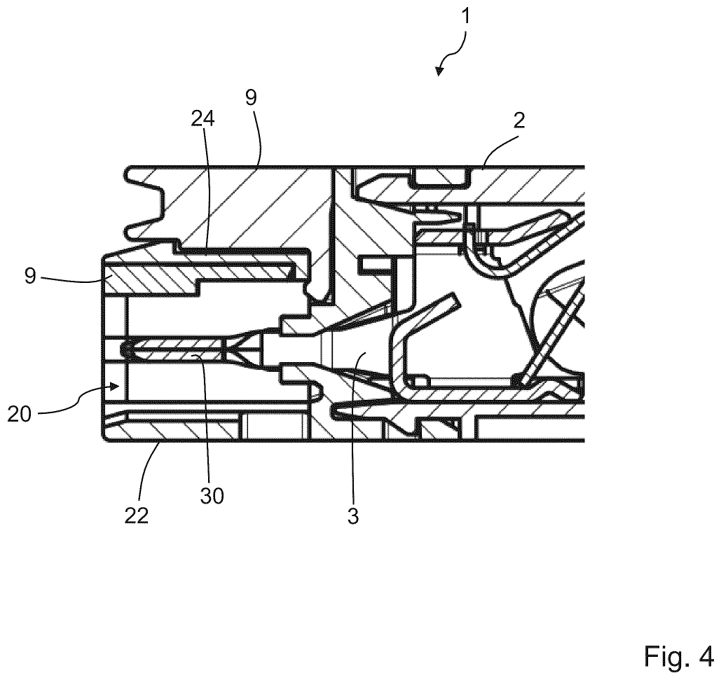

FIG. 3 shows a part of the pluggable connector 1 in a lateral sectional view together with a part of a mating connector 6. According to FIG. 3, neither the first fastening element 4 nor the second fastening element 5 has a functional element 9 attached, so that the fastening elements 4, 5 are clearly visible. According to FIG. 4, for example, both the first fastening element 4 and the second fastening element 5 each have a functional element 9 attached.

The first fastening elements 5 may be located on the outside of the housing 2, in particular outside the contact chamber 20. As can be seen in FIGS. 3 and 4, a first fastening element 4 can also extend in whole or in part through a housing wall of the housing 2 and possibly extend into an area located within the contact chamber 20. It is also possible that a functional element 9 attached to a first fastening element 4, which is predominantly located outside the contact chamber 20, extends, e.g., with a fastening section into the interior of the housing 2 or at least into the interior of the contact chamber 20.

A first fastening element 4 can, for example, be designed as the first receiving groove, which extends in its longitudinal direction perpendicular to the plug direction S and/or perpendicular to the row direction A. For example, a functional element 9 can be inserted into the receiving groove from above onto the housing 2 and then guided in the direction of a sidewall 24 bounding the contact chamber 20 until it engages with a locking element on the first fastening element 4.

As can be seen in the figures, a first fastening element 5 can merge into an associated second fastening element 4. It is also possible that the second fastening element 4 and the first fastening element 5 are separated from each other and do not intersect or overlap.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A pluggable connector of an electrical plug connection comprising the pluggable connector and a mating connector assigned to the pluggable connector to which the pluggable connector is pluggable in a plug direction, the pluggable connector comprising:
a housing;
at least two electrical plug contacts at least partially arranged in the housing, each of the at least two electrical plug contacts having a plug section, which is designed to come into contact mechanically and electrically with a mating plug contact of the mating connector,
at least one first fastening element; and
at least one second fastening element,
wherein the housing has a contact chamber for accommodating the plug sections of the plug contacts,
wherein the contact chamber, at least in an area of the plug sections arranged therein, has circumferential sidewalls,
wherein the at least one first fastening element is designed for attaching a functional element to the housing outside the contact chamber, and
wherein the at least one second fastening element is set up for attaching a functional element to the housing within the contact chamber.

2. The pluggable connector according to claim 1, wherein the at least one second fastening element is arranged on a sidewall of the contact chamber.

3. The pluggable connector according to claim 1, wherein the at least one second fastening element is formed as a second receiving groove or as a receiving groove with an undercut.

4. The pluggable connector according to claim 3, wherein the second receiving groove extends in its longitudinal direction in the plug direction.

5. The pluggable connector according to claim 1, wherein the at least one first fastening element is formed as the first receiving groove or as a receiving groove with an undercut.

6. The pluggable connector according to claim 5, wherein the first receiving groove extends in its longitudinal direction perpendicular to the plug direction and/or substantially perpendicular to a row direction of the plug contacts.

7. The pluggable connector according to claim 1, wherein the pluggable connector is designed as a pin header, and wherein the plug sections of the plug contacts are formed as contact pins protruding into the contact chamber.

8. The pluggable connector according to claim 1, wherein the pluggable connector has several second fastening elements and/or several first fastening elements.

9. The pluggable connector according to claim 1, wherein, for one, several or all of the second fastening elements each are spatially assigned to a plug contact of the pluggable connector.

10. The pluggable connector according to claim 1, wherein for one, several or all of the first fastening elements each are spatially assigned to a plug contact of the pluggable connector.

11. The pluggable connector according to claim 1, wherein at least one second fastening element and/or at least one of the first fastening elements is formed as a universal fixing element for fixing different functional elements to the housing to be selected by the user.

12. The pluggable connector according to claim 1, wherein the at least one first fastening element is arranged in the plug direction in alignment with a second fastening element assigned to the at least one first fastening element.
